(19) United States
(12) Patent Application Publication
(10) Pub. No.: US 2013/0044160 A1
(43) Pub. Date: Feb. 21, 2013

(54) PRINTER AND PRINTING WITH BOUNDARY LAYER DISRUPTION

(71) Applicants: Kelly Ronk, San Diego, CA (US); Clayton L. Holstun, San Marcos, CA (US); Thomas M. Sabo, San Diego, CA (US)

(72) Inventors: Kelly Ronk, San Diego, CA (US); Clayton L. Holstun, San Marcos, CA (US); Thomas M. Sabo, San Diego, CA (US)

(21) Appl. No.: 13/209,922

(22) Filed: Aug. 15, 2011

(51) Int. Cl. B41J 23/00

(52) U.S. Cl. 347/37

(57) ABSTRACT

A printer for printing on a print medium includes a print module supporting at least one printhead having ink orifices formed in a front face thereof through which ink drops are ejected into a print zone between the printhead and the print medium during printing, and a member extending beyond the front face of the printhead toward the print medium from the print module adjacent the printhead, wherein the member disrupts a boundary layer of air in the print zone between the printhead and the print medium during printing.

### BACKGROUND

Print defects such as worms (swirling areas of lighter and darker print) and edge roughness detract from the overall image quality of inkjet prints. Unfortunately, printing at higher speeds (to achieve, for example, higher throughput) and at higher pen-to-paper spacings (PPS) (to accommodate, for example, a greater range of print medium thickness) exacerbates these defects.

### BRIEF DESCRIPTION OF THE DRAWINGS

FIG. 1 is a schematic end view illustrating one example of a portion of an inkjet printer including a boundary layer disruptor.

FIG. 2 is a schematic end view illustrating another example of a portion of an inkjet printer including a boundary layer disruptor.

FIG. 3 is a schematic bottom perspective view illustrating one example of a portion of an inkjet printer including a boundary layer disruptor.

FIG. 4 is a schematic bottom perspective view illustrating another example of a portion of an inkjet printer including a boundary layer disruptor.

FIG. 5 is a schematic bottom perspective view illustrating one example of a portion of an inkjet printer including a boundary layer disruptor.

FIG. 6 is an enlarged portion of an image printed by an inkjet printer without a boundary layer disruptor.

FIG. 7 is an enlarged portion of an image printed by an inkjet printer including a boundary layer disruptor.

### DETAILED DESCRIPTION

In the following detailed description, reference is made to the accompanying drawings which form a part hereof, and in which is shown by way of illustration specific examples in which the disclosure may be practiced. In this regard, directional terminology, such as “top,” “bottom,” “front,” “back,” “leading,” “trailing,” etc., is used with reference to the orientation of the Figure(s) being described. Because components of examples of the present disclosure can be positioned in a number of different orientations, the directional terminology is used for purposes of illustration and is in no way limiting. It is to be understood that other examples may be utilized and structural or logical changes may be made without departing from the scope of the present disclosure. The following detailed description, therefore, is not to be taken in a limiting sense, and the scope of the present disclosure is defined by the appended claims.

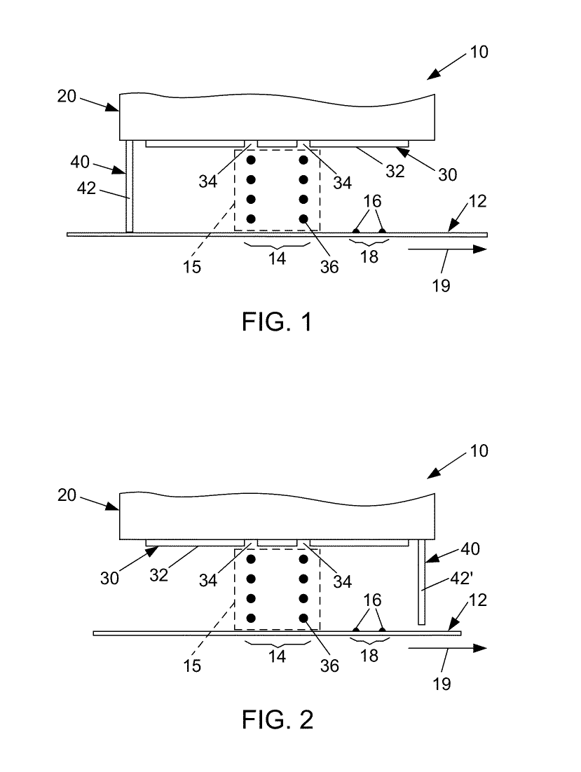

FIGS. 1 and 2 illustrate examples of a portion of an inkjet printer 10 for printing on a print medium 12. Inkjet printer 10 includes a print module 20, a printhead 30, and a boundary layer disruptor 40. Print medium 12 includes a print region 14 within which print 16 in the form of characters and graphics is created as relative movement between printhead 30 and print medium 12 occurs during printing. Print medium 12 is any type of suitable material including sheet material such as paper, cardstock, transparencies, Mylar, and the like.

Printhead 30 is supported by print module 20, and has a front face 32 in which a plurality of ink orifices or nozzles 34 are formed. In one example, during printing, printhead 30 is held stationary as print medium 12 moves in a printing direction, as indicated by arrow 19.

Examples of printhead 30 include a thermal printhead, a piezoelectric printhead, a flex-tensional printhead, or any other type of inkjet ejection device. If printhead 30 is, for example, a thermal printhead, printhead 30 typically includes a substrate layer (not shown) having a plurality of resistors (not shown) which are operatively associated with ink orifices 34. Upon energization of the resistors, in response to command signals delivered by a controller (not shown) to printhead 30, drops of ink 36 are ejected through ink orifices 34 toward print medium 12.

During printing, ink drops 36 are ejected through ink orifices 34 and from printhead 30 toward print region 14 of print medium 12 to create print 16. As print medium 12 moves in the printing direction indicated by arrow 19, print 16 creates an already-imprinted region 18 on print medium 12. Ink drops 36 are ejected from printhead 30 into a print zone 15 with an intended ink drop trajectory. Print zone 15 is defined as being between printhead 30 and print medium 12, and encompasses ink drops 36. The intended ink drop trajectory is defined by a plurality of ink drops 36 ejected toward print medium 12 to form a “curtain” of ink drops 36 extending between printhead 30 and print medium 12. In one example, the intended ink drop trajectory is substantially perpendicular to print region 14 of print medium 12.

Boundary layer disruptor 40 disrupts a boundary layer of air formed between printhead 30 and print medium 12 during printing. For example, as print medium 12 moves relative to printhead 30 during printing, a boundary layer of air may develop over a surface of print medium 12. As such, the boundary layer of air may affect the intended ink drop trajectory of ink drops 38 during printing, thereby degrading image quality. By disrupting the boundary layer of air formed between printhead 30 and print medium 12, however, boundary layer disruptor 40 helps to reduce or prevent print defects caused by the boundary layer of air.

In one example, as illustrated in FIG. 1, boundary layer disruptor 40 includes a member 42 extended toward print medium 12 from print module 20 adjacent printhead 30. As such, member 42 extends substantially perpendicular to a plane of print medium 12 and substantially perpendicular to a plane of front face 32 of printhead 30. Thus, member 42 extends substantially parallel with the intended ink drop trajectory and substantially perpendicular to print region 14 of print medium 12 toward which ink drops 36 are ejected.

As illustrated in the example of FIG. 1, member 42 is positioned before print zone 15 relative to the printing direction indicated by arrow 19 so as to extend toward an “ink dry side” of print medium 12. As such, member 42 is positioned “upstream” of print zone 15 on a pre-print side of print medium 12 relative to the printing direction indicated by arrow 19.

In another example, as illustrated in FIG. 2, boundary layer disruptor 40 includes a member 42′ extended toward print medium 12 from print module 20 adjacent printhead 30. Similar to member 42, member 42′ is extended toward print medium 12 from print module 20 adjacent printhead 30. As such, member 42′ extends substantially perpendicular to a plane of print medium 12 and substantially perpendicular to a plane of front face 32 of printhead 30. Thus, member 42′ extends substantially parallel with the intended ink drop trajectory and substantially perpendicular to print region 14 of print medium 12 toward which ink drops 36 are ejected.

As illustrated in the example of FIG. 2, however, member 42′ is positioned after print zone 15 relative to the printing direction indicated by arrow 19 so as to extend toward an “ink wet side” of print medium 12. As such, member 42′ is positioned “downstream” of print zone 15 on a post-print side of print medium 12 relative to the printing direction indicated by arrow 19.

Although boundary layer disruptor 40 is illustrated and described in one example as including member 42 on a pre-print side of print medium 12 and illustrated and described in another example as including member 42′ on a post-print side of print medium 12, boundary layer disruptor 40 may include both member 42 on a pre-print side of print medium 12 and member 42′ on a post-print side of print medium 12 such that inkjet printer 10 includes two boundary layer disruptors.

Member 42 (including member 42′) extends beyond or below front face 32 of printhead 30 into a spacing (i.e., pen-to-paper spacing) defined between a plane of front face 32 of printhead 30 and a plane of print medium 12. In one example, as illustrated in FIG. 1, member 42 extends to print medium 12 such that an end of member 42 contacts print medium 12. In another example, as illustrated in FIG. 2, member 42′ extends toward print medium 12 such that an end of member 42′ is spaced from print medium 12 and in non-contact with print medium 12. Although member 42 is illustrated and described as being in contact with print medium 12 and member 42′ is illustrated and described as being in non-contact with print medium 12, member 42 may be in non-contact with print medium 12 and member 42′ may be in contact with print medium 12.

With an end of member 42′ (or member 42) spaced from print medium 12 and in non-contact with print medium 12, varying thickness of print medium 12 may be more easily accommodated when relying on non-contact with print medium 12. In addition, non-contact with print medium 12 avoids potential smearing of print 16 when member 42′ is positioned after print zone 15 on the “ink wet side” of print medium 12.

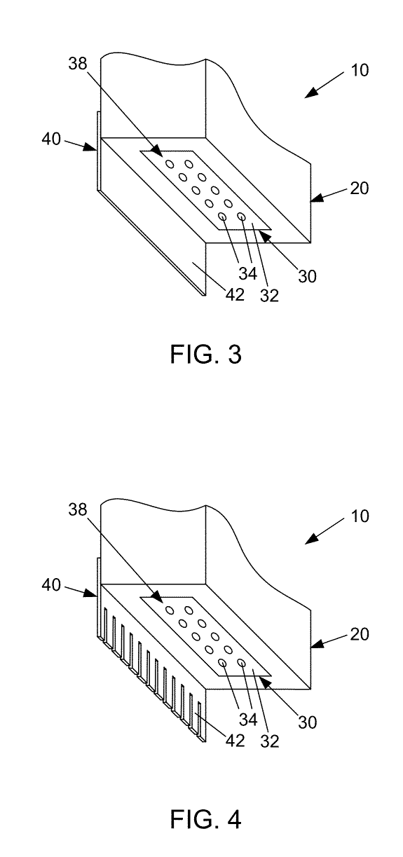

In one example, as illustrated in FIG. 3, member 42 (including member 42′) is formed of a solid panel of material. In another example, as illustrated in FIG. 4, member 42 (including member 42′) is formed of a fringed panel of material such that the fringed panel of material includes, for example, a band of material with, for example, strips, threads or fibers hanging or extending from the band of material. In one example, as either a solid panel of material or a fringed panel of material, member 42 (including member 42′) is flexible in construction and formed of a flexible material or materials (such as fabric materials). In another example, as either a solid panel of material or a fringed panel of material, member 42 (including member 42′) is rigid or semi-rigid in construction and formed of a rigid or semi-rigid material or materials.

As illustrated, for example, in FIGS. 3 and 4, ink orifices 34 are arranged in one or more columns 38 of ink orifices 34. As such, in one example, member 42 (including member 42′) extends substantially parallel with column 38 of ink orifices 34. In addition, in one example, member 42 (including member 42′) extends a length of printhead 30, including at least a length of column 38 of ink orifices 34. In one example, in extending a length of printhead 30, member 42 (including member 42′) extends a length of print module 20 beyond a length of printhead 30. While illustrated as extending a length of printhead 30, including extending at least a length of column 38 of ink orifices 34, member 42 (including member 42′) may extend more than or less than a full length of printhead 30, and may extend more than or less than a full length of column 38 of ink orifices 34. In addition, member 42 (including member 42′) may extend more than or less than a full length of print module 20.

As illustrated in FIGS. 3 and 4, member 42 (including member 42′) has a substantially uniform thickness or width over a length thereof, and has a substantially uniform height over a length thereof (as measured in a direction substantially perpendicular to a plane of front face 32 of printhead 30) such that an amount by which member 42 (including member 42′) extends beyond a plane of front face 32 of printhead 30 is substantially uniform over a length of member 42 (including member 42′). In addition, a length of member 42 (including member 42′) (in a direction substantially parallel with column 38 of ink orifices 34) is greater than a thickness of member 42, and a height of member 42 (including member 42′) (in a direction substantially perpendicular to front face 32 of printhead 30) is greater than a thickness of member 42.

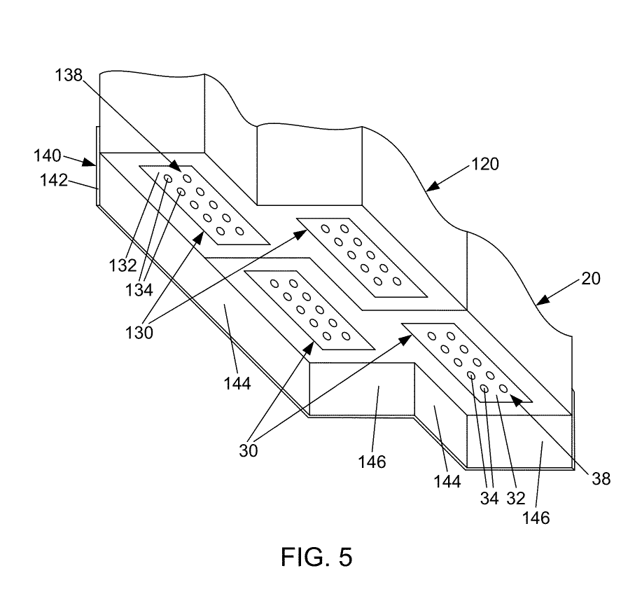

In one example, as illustrated in FIG. 5, printhead 30 is one of multiple printheads 30 supported by print module 20. Printheads 30 are spaced apart and staggered such that printheads 30 are offset from and partially overlap each other. As such, the multiple printheads produce a wider print swath than one printhead 30 alone.

As illustrated in the example of FIG. 5, a plurality of print modules 20,120 each supporting multiple printheads 30,130 are mounted adjacent to each other in an end-to-end manner such that at least one printhead 30 of print module 20 overlaps at least one printhead 130 of adjacent print module 120. As such, print modules 20,120 may span a nominal page width or a width shorter than or longer than a nominal page width. While two print modules 20,120 each supporting two printheads 30,130 are illustrated, the number of printheads 30,130 supported by each print module 20,120, as well as the number of print modules 20,120, may vary.

FIG. 5 illustrates another example of a boundary layer disruptor 140. Boundary layer disruptor 140, similar to boundary layer disruptor 40, includes a member 142 extended toward print medium 12 (FIGS. 1 and 2) from print modules 20,120 adjacent printheads 30,130. As such, member 142 extends substantially perpendicular to a plane of print medium 12 and substantially perpendicular to a plane of front face 32,132 of printheads 30,130. Member 142 extends a length of printheads 30,130 and, in one example, extends a length of print modules 20,120. As such, member 142 includes portions 144 extending substantially parallel with columns 38,138 of ink orifices 34,134, and portions 146 extending substantially perpendicular to columns 38,138 of ink orifices 34,134.

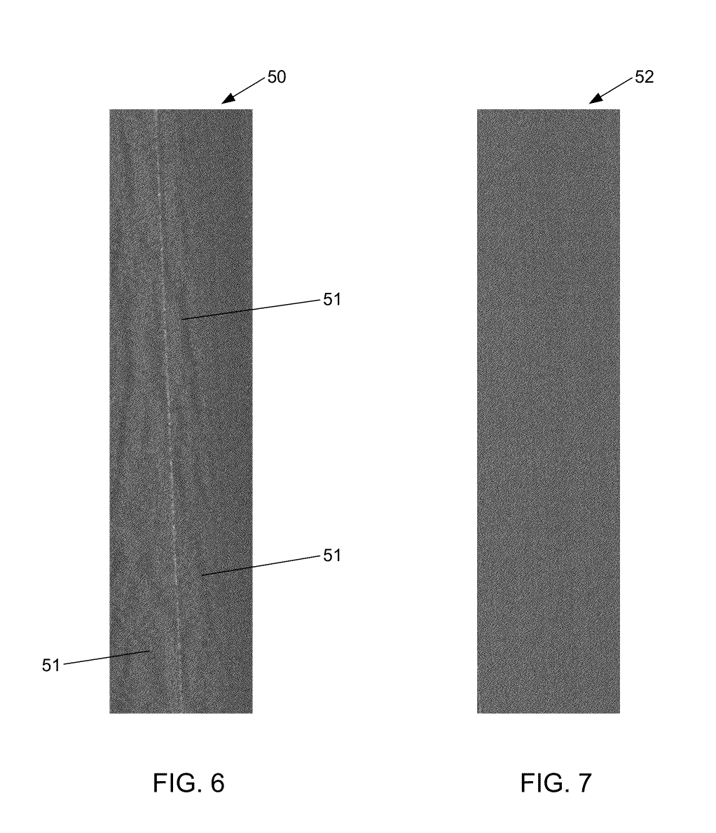

FIGS. 6 and 7 illustrate enlarged image portions printed by an inkjet printer without and with, respectively, a boundary layer disruptor as described herein. FIG. 6 illustrates an enlarged image portion 50 printed without a boundary layer disruptor as described herein. As illustrated in FIG. 6, enlarged image portion 50 includes print defects 51 which are identifiable by dark lines or patches in areas of uniform gray. Print defects 51, commonly referred to as “worms,” produce a patterned or mottled appearance and, as such, degrade image quality.

FIG. 7 illustrates an enlarged image portion 52 printed with a boundary layer disruptor as described herein. As illustrated in FIG. 7, enlarged image portion 52 does not include print defects 51 identifiable in FIG. 6. Thus, image quality is enhanced with a boundary layer disruptor as described herein.

By extending toward print medium 12 from print module 20 (including print module 120) adjacent printhead(s) 30 (including printhead(s) 130), boundary layer disruptor 40 (including boundary layer disruptor 140) disrupts a boundary layer of air which may develop over a surface of print medium 12 during printing. As such, undesirable print defects 51, such as “worms,” are reduced or prevented.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A printer for printing on a print medium, the printer comprising:
a print module supporting at least one printhead having ink orifices formed in a front face thereof through which ink drops are ejected into a print zone between the printhead and the print medium during printing; and
a member extending beyond the front face of the printhead toward the print medium from the print module adjacent the printhead, wherein the member disrupts a boundary layer of air in the print zone between the printhead and the print medium during printing.

2. The printer of claim 1, wherein the ink orifices comprise at least one column of ink orifices, and wherein the member extends substantially parallel with the at least one column of ink orifices.

3. The printer of claim 2, wherein the member further extends substantially perpendicular to the at least one column of ink orifices.

4. The printer of claim 1, wherein the member is positioned before the print zone.

5. The printer of claim 1, wherein the member is positioned after the print zone.

6. The printer of claim 1, wherein the member contacts the print medium.

7. The printer of claim 1, wherein the member is in non-contact with the print medium.

8. The printer of claim 1, wherein the member comprises a solid member.

9. The printer of claim 1, wherein the member comprises a fringed member.

10. The printer of claim 1, wherein the at least one printhead comprises a first printhead and a second printhead offset from and partially overlapping the first printhead, wherein the member extends a length of the first printhead and the second printhead.

11. A printer for printing on a print medium, the printer comprising:
a print module supporting at least one printhead having ink orifices formed in a front face thereof through which ink drops are ejected into a print zone between the printhead and the print medium during printing; and
means extending beyond the front face of the printhead toward the print medium from the print module adjacent the printhead for disrupting a boundary layer of air in the print zone between the printhead and the print medium during printing.

12. The printer of claim 11, wherein the means extending beyond the front face of the printhead toward the print medium from the print module adjacent the printhead extends substantially parallel with a column of the ink orifices.

13. A method of printing on a print medium with a printer including a print module supporting a printhead having ink orifices formed in a front face thereof, the method comprising:
ejecting drops of ink through the ink orifices into a print zone between the printhead and a print medium; and
disrupting a boundary layer of air in the print zone between the printhead and the print medium with a member extending beyond the front face of the printhead toward the print medium from the print module adjacent the printhead.

14. The method of claim 13, wherein disrupting the boundary layer of air includes positioning the member before the print zone.

15. The method of claim 13, wherein disrupting the boundary layer of air includes positioning the member after the print zone.
